(19) United States
(12) Patent Application Publication
(10) Pub. No.: US 2024/0123660 A1
(43) Pub. Date: Apr. 18, 2024

(54) HYBRID COMPONENT FOR AUTOMOTIVE APPLICATIONS AND METHOD OF MANUFACTURING A HYBRID COMPONENT

(71) Applicant: Hella GmbH & Co. KGaA, Lippstadt (DE)

(72) Inventors: Frank Brinkmeier, Lippstadt (DE); Michael Lakenbrink, Oelde (DE); Thomas Wiese, Lippstadt (DE)

(21) Appl. No.: 18/394,234

(22) Filed: Dec. 22, 2023

Related U.S. Application Data
(63) Continuation of application No. PCT/EP2021/067636, filed on Jun. 28, 2021.

(51) Int. Cl. B29C 45/14

(52) U.S. Cl. CPC B29C 45/14336; B29L 2031/3002

(57) ABSTRACT

A hybrid component is provided for automotive applications, and includes a sheet metal component and at least one plastic support component. The at least one plastic support component is positively connected to the sheet metal component. A decor section of the sheet metal component includes a colour coating pattern generating a dedicated aesthetic design appeal.

### CROSS REFERENCE

This application claims priority to PCT Application No. PCT/EP2021/067636, filed Jun. 28, 2021, the entirety of which is hereby incorporated by reference.

### FIELD OF THE INVENTION

The present invention relates to a hybrid component for automotive applications, especially for a front panel, for a bumper or for a housing of a lighting device. The invention furthermore relates to a method of manufacturing a hybrid component.

### BACKGROUND OF THE INVENTION

In addition to purely technical requirements, visible components in the periphery of motor vehicles must also meet aesthetic and design demands. This applies, for example, to front and rear aprons, to bumpers, to front panels, which are used instead of a radiator grille in electric vehicles in particular, as well as to lighting equipment, especially for sections of their housings that are visible from the outside. The technical functionality of the components relates in particular to their mechanical or thermomechanical properties, such as rigidity and load-bearing capacity or the distortion and warpage behaviour under thermal load cycles. With regard to the aesthetic design appeal, a metal look is often required, i.e., a surface that corresponds to a metal in terms of colour and gloss or also reproduces the typical impression of a rough, for example brushed, metal surface. In addition, it may be intended to provide the metallic-looking visible component surfaces with coloured patterns as applications. In the prior art, plastic components, for example made of thermoplastics or thermosets, are usually used as structural elements and, in order to achieve the desired aesthetic appearance, the visible surfaces are covered with printed or otherwise appropriately designed foils, for example by means of bonding or back injection moulding.

### BRIEF SUMMARY OF THE INVENTION

It is an object of the present invention to propose an alternative embodiment of a component for the aforementioned applications which satisfies both mechanic-structural and aesthetic design requirements.

The invention discloses the technical teaching that the hybrid component comprises a sheet metal component and at least one plastic support component which is positively connected to the sheet metal component, wherein a decor section of the sheet metal component features a colour coating pattern generating a dedicated aesthetic design appeal.

The invention is based on the idea of introducing the sheet metal component as a central element which, on the one hand, features excellent mechanical and thermo-mechanical properties and, on the other hand, intrinsically ensures a desired metal look for design purposes. The decor section is the one section of the sheet metal component which can be seen by an outside observer in the intended installation position of the hybrid component on the motor vehicle. The decor section is provided with a colour coating pattern of any design in principle, such a pattern also being able, for example, to form a monochrome colouring of the entire surface of the decor section. In particular, however, the invention is aimed at combining a metallic-looking base surface of the decor section with a colour coating pattern applied thereto, wherein the colour coating pattern only partially covers the decor section and/or features partial transparency, so that the metallic appearance of the sheet metal component may remain visible for an observer. The colour coating pattern may also comprise a semi-transparent decorative layer covering the entire decor section. The at least one plastic component is provided for connecting the hybrid component to a motor vehicle and/or for additional stiffening of the hybrid component. With regard to the thermomechanical properties, the hybrid component is characterised by the low, isotropic and fully reversible thermal expansion of the sheet metal component, whereas the comparatively small-dimensioned plastic support components contribute only marginally to thermal distortion in absolute terms.

The decor section corresponds, for example, to a front side of the hybrid component which is visible from the outside in an intended installation position on a motor vehicle, such as in the case of a panel in the front-of-car area. If the hybrid component represents a housing of a lighting device, in particular a headlamp, the decor section can be formed by those housing sections which are visible when looking through the cover lens of the lighting device. The hybrid component may furthermore represent a decorative component which is positioned inside a housing and visible through the cover lens. In particular, the decor section of the hybrid component according to the invention does not have to form a continuous surface; rather, the decor section can also consist of a plurality of section of the sheet metal component that are spaced apart from one another.

As an advantageous embodiment the decor section features an anodized layer wherein the colour coating pattern is enclosed in the anodized layer. By embedding the colour coating pattern in the pores of a surface oxide layer formed by anodizing, a particularly high-quality optical appearance is created and, furthermore, the colour coating pattern is enclosed in an abrasion-protected manner, at least after subsequent sealing of the anodised layer.

In another embodiment the decor section is covered by a transparent or translucent protection layer. Such a protection layer serves to protect the decor section from wear, in particular from stone chipping or discolouration of the colour coating pattern due to UV radiation from sunlight. The protection layer can be completely transparent or features translucency as an additional design function, for example, the protection layer can be semi-transparent and coloured.

In another embodiment the sheet metal component comprises at least one opening, especially in the decor section, wherein the opening is intended for a sensor window or for backlighting the hybrid component. For example, the opening can be provided to accommodate a radome.

In particular a cover pane and/or a metal mesh, especially an expanded metal sheet or a metal wire mesh, is inserted in the opening and connected to the sheet metal component and/or to the plastic support component. The cover pane, in particular made of a plastic, and with some restrictions also an open-pored metal mesh is permeable to radio waves and can thus function as a radar window for a motor vehicle radar unit to be arranged behind it. The use of a metal mesh covering the opening extends the design scope of the hybrid component. In particular, the opening can be covered by a hybrid component, i.e., a plastic cover pane with an integrated metal mesh, especially formed by back-moulding. The cover pane and/or the metal mesh can, for example, be glued to the sheet metal component, but preferably it is positively connected to the plastic component and attached to the hybrid component via the latter.

Advantageously the sheet metal component features an aluminium alloy. Aluminium alloys are particularly suitable for an appropriate anodising treatment for embedding the colour pattern in an anodised surface layer of the decor section.

In particular the plastic support component features a stiffening structure and/or mounting means. The stiffening structure can, for example, be designed as stiffening ribs and the connecting means, for example, as screw domes, which serve to connect the hybrid component to a motor vehicle. Furthermore, the at least one plastic component can serve as a receptacle for electronic components to be arranged on the hybrid component, in particular sensors or illuminants.

The invention furthermore concerns a method of manufacturing a hybrid component for automotive applications, especially for a front apron, for a rear apron, for a front panel, for a bumper or for a housing of a lighting device, comprising at least the following steps without a fixed order: providing a sheet metal component made of an aluminium alloy; applying a colour coating pattern to a decor section of the sheet metal component generating a dedicated aesthetic design appeal, and injection-moulding of at least one plastic support component to the sheet metal component forming a positive connection.

The method is particularly suitable for manufacturing a hybrid component according to one of the aforementioned embodiments of the invention.

In order to form a load-bearing positive connection between the metal component and the moulded-on plastic support component, for example, local micro-structuring of the sheet metal component surface can be carried out with the formation of undercuts, for example by means of chemical etching or laser patterning, in such a way that form-locking micro-connections are formed between the sheet metal component and the plastic support component.

For instance, the colour coating pattern is applied by means of inkjet printing, pad printing, screen printing, lacquering or by attaching a foil or a sticker.

In a preferred embodiment of the inventive method, the decor section is anodized before applying the colour coating pattern, wherein the decor section is sealed after applying the colour coating pattern. This procedure corresponds to the well-known aluminium anodising process (eloxal), whereby the desired colour coating pattern is introduced into the porous surface oxide layer formed by anodic oxidation of the decor section, for example by means of inkjet printing, and a surface sealing is then carried out in which the colour coating pattern is enclosed in the anodised layer.

According to another embodiment, a transparent or translucent protection layer is injection-moulded to the decor section after applying the colour coating pattern. The injection moulding of this protective layer is carried out, for example, in one step with the injection moulding of the plastic component or, alternatively, a multi-stage injection moulding process is carried out, in particular if different plastics are provided for the plastic component and the protective layer.

In another embodiment the sheet metal component is provided with at least one opening, especially in the decor section, and with a cover pane and/or a metal mesh, especially an expanded metal sheet or a metal wire mesh, inserted in the opening, wherein the injection-moulding creates a positive connection of the plastic support component and the cover pane and/or the metal mesh. For instance, the cover pane can be provided from a plastic with an integrated metal mesh.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIGS. 1-3 illustrate front views of intermediate products of the method of manufacturing a hybrid component.

FIG. 4a is a front view of a first embodiment of the hybrid component.

FIG. 4b is a rear view of the first embodiment.

FIG. 4c is a cross-section view of the first embodiment.

FIG. 5a is a front view of a second embodiment of the hybrid component.

FIG. 5b is a rear view of the second embodiment.

FIG. 5c is a cross-section view of the second embodiment.

### DETAILED DESCRIPTION OF THE DRAWINGS

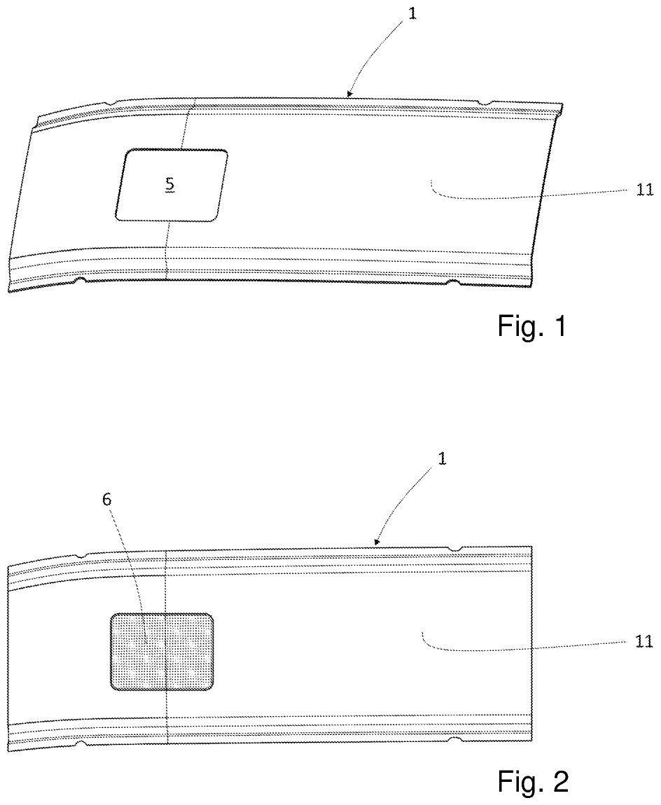

FIG. 1 to FIG. 3 show front views of intermediate products of the method of manufacturing a hybrid component according to the invention.

FIG. 1 shows the sheet metal component 1, the entire front side of which forms the decor section 11. In an intended installation position as a panel in the front of a motor vehicle, the decor section 11 is visible to a passer-by. The sheet metal component 1 is preferably made of an aluminium alloy and has a thickness of, for example, 1-2 mm. The sheet-metal component 1 can be shaped by a conventional forming process, for example a punching-bending process. The sheet metal component 1 has the opening 5 which is provided as a sensor opening for a radar sensor to be arranged behind it.

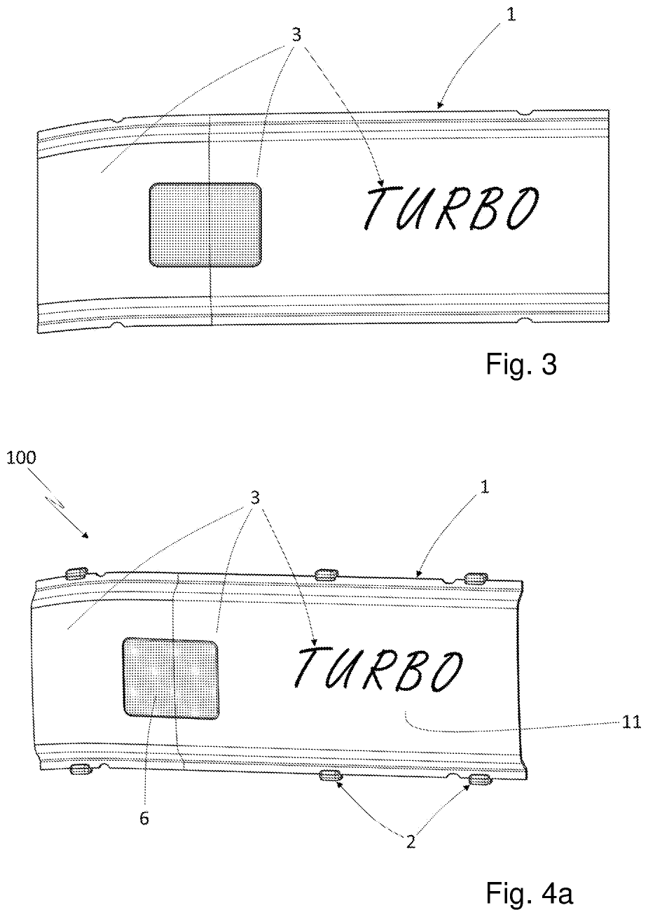

FIG. 2 shows the sheet metal component 1, wherein a cover pane 6 transparent to radio waves, for example made of polycarbonate, has been inserted into the opening 5. For further handling, the cover pane 6 can be attached to the sheet metal component 1 by means of a temporary pre-fixation.

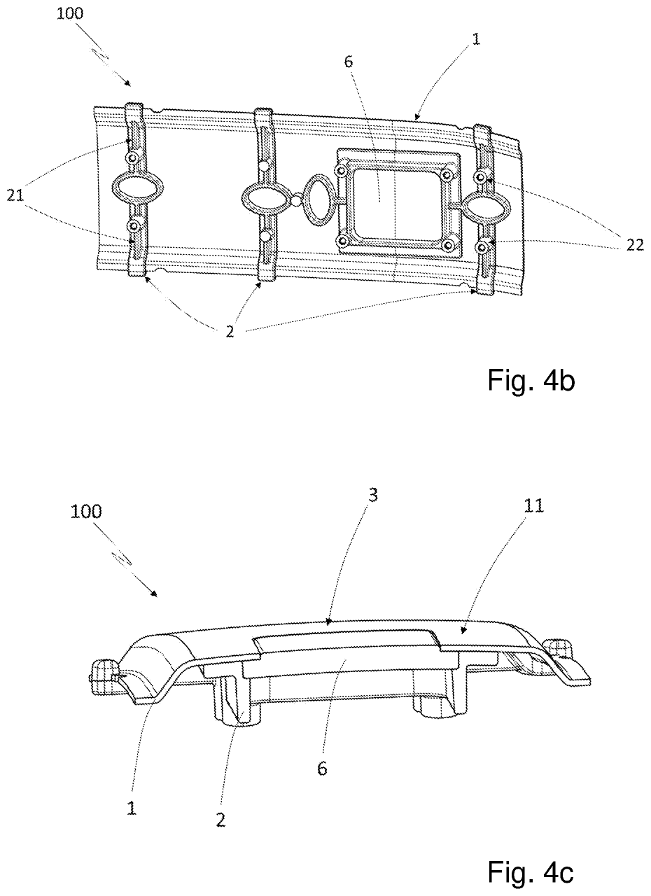

FIG. 3 shows the sheet metal component 1 after the application of the colour coating pattern 3 to the decor section 11. The colour coating pattern 3 consists here, as an example, of a coloured, semi-transparent covering of the entire decor section 11 (not visible in the black and white line graph of FIG. 3), through which the metallic surface appearance of the decor section 11 remains visible, as well as of the additionally applied lettering “TURBO” in a different colour. The cover pane 6 is also covered by the colour coating pattern 3.

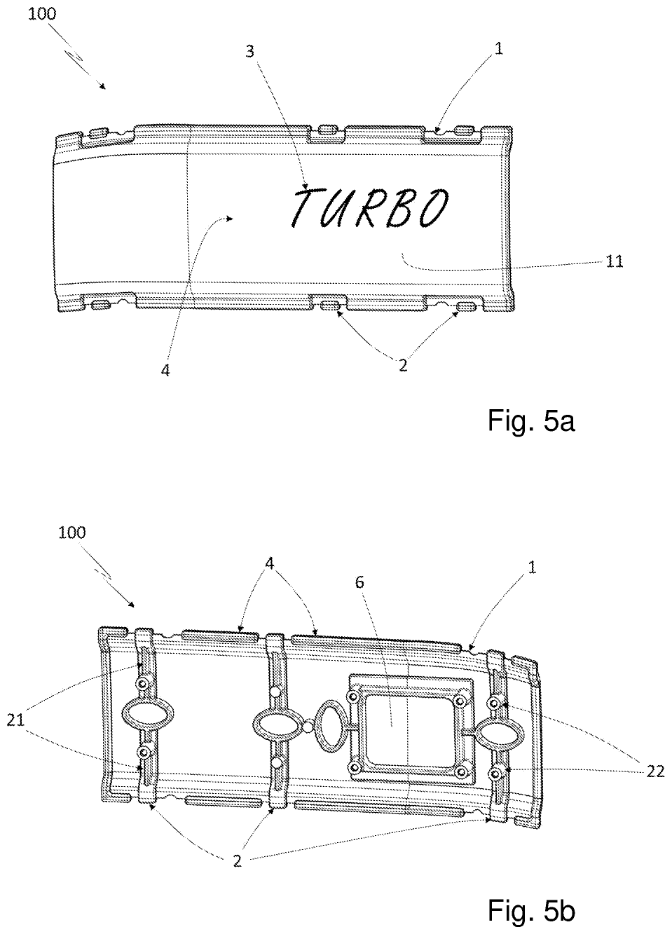

FIG. 4a to FIG. 4c show a front, rear and cross-section view of a first embodiment of the hybrid component 100 according to the invention, in which the plastic support components 2 have been positively connected to the sheet metal component 1 by means of injection-moulding as the final step of the manufacturing process in this example. The rib-shaped stiffening structures 21 and the mounting means 22 in the form of screw bosses form sections of the plastic support components 2. The stiffening structures 21 counteract deflection of the sheet metal component 1 and the mounting means 22 serve to connect the hybrid component 100 to a motor vehicle or to arrange a radar unit behind the opening 5 with the cover pane 6. The cover pane 6 is positively connected to the corresponding plastic support component 2 and integrated into the hybrid component 100 via the latter.

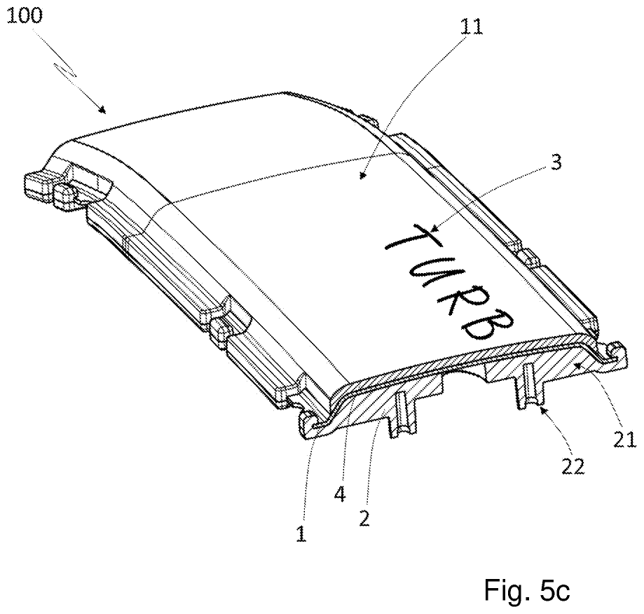

FIG. 5a to FIG. 5c show a front, rear and cross-section view of a second embodiment of the hybrid component 100 according to the invention, in which the decorative section 11 of the sheet metal component 1 together with the colour coating pattern 3 applied thereto is covered by the transparent protection layer 4. The protection layer 4 consists of a suitable plastic and has been attached to the sheet metal component 1 by means of injection-moulding. Due to the transparency of the protective layer 4, the metallic-looking surface of the decorative section 11 and the colour coating pattern 3 are still visible. The protection layer 4 serves as a wear protection layer, in particular against scratching and/or UV bleaching.

The present invention is not limited by the embodiments described above which are represented as examples only and can be modified in various ways within the scope of protection defined by the appending patent claims.

### LIST OF NUMERALS

100 hybrid component
1 sheet metal component
11 decor section
2 plastic support component
21 stiffening structure
22 mounting means
3 colour coating pattern
4 protection layer
5 opening
6 cover pane

We claim:

1. A hybrid component for automotive applications, the hybrid component comprising:
a sheet metal component; and
at least one plastic support component positively connected to the sheet metal component;
wherein a decor section of the sheet metal component includes a colour coating pattern generating a dedicated aesthetic design appeal.

2. The hybrid component according to claim 1, wherein the decor section includes an anodised layer, wherein the colour coating pattern is enclosed in the anodised layer.

3. The hybrid component according to claim 1, wherein the decor section is covered by a transparent or translucent protection layer.

4. The hybrid component according to claim 1, wherein the sheet metal component further includes at least one opening, wherein the opening is a sensor window or allows for backlighting.

5. The hybrid component according to claim 4, wherein a cover pane and/or a metal mesh is inserted in the opening, and is connected to the sheet metal component and/or to the plastic support component.

6. The hybrid component according to claim 1, wherein the sheet metal component includes an aluminium alloy.

7. The hybrid component according to claim 1, wherein the plastic support component includes a stiffening structure and/or mounting means.

8. A method of manufacturing a hybrid component for automotive applications, the method comprising the following steps without a fixed order:
providing a sheet metal component made of an aluminium alloy,
applying a colour coating pattern to a decor section of the sheet metal component generating a dedicated aesthetic design appeal, and
injection-moulding at least one plastic support component to the sheet metal component forming a positive connection.

9. The method according to claim 8, wherein the colour coating pattern is applied by inkjet printing, pad printing, screen printing, lacquering or by attaching a foil or a sticker.

10. The method according to claim 8, wherein the decor section is anodized before applying the colour coating pattern, wherein the decor section is sealed after applying the colour coating pattern.

11. The method according to claim 8, wherein a transparent or translucent protection layer is injection-moulded to the decor section after applying the colour coating pattern.

12. The method according to claim 8, wherein the sheet metal component is provided with at least one opening, and with a cover pane and/or a metal mesh inserted in the opening, wherein the injection-moulding creates a positive connection of the plastic support component and the cover pane and/or the metal mesh.
